(19) United States
(12) Patent Application Publication
(10) Pub. No.: US 2009/0119607 A1
(43) Pub. Date: May 7, 2009

(54) INTEGRATION OF DISPARATE RENDERING PLATFORMS

(75) Inventors: Daniel Joseph Giambalvo, Seattle, WA (US); Karim Taji Farouki, Seattle, WA (US); Gregory David Swedberg, Bellevue, WA (US); Daniel Jason Tomko, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/934,425

(22) Filed: Nov. 2, 2007

(51) Int. Cl. G06F 3/00

(52) U.S. Cl. 715/762

(57) ABSTRACT

A method and a processing device may be provided in which a number of disparate rendering platforms may be integrated to render a single integrated scene. The disparate rendering platforms may include logical trees of controls, which may define relationships among the controls. An integrated logical tree may formed from the logical trees of the disparate rendering platforms. At least some of the controls, related to a first rendering platform, may act as placeholders with respect to a second rendering platform. One of a number of different hosting modes may be employed to build upon the integrated logical tree to integrate the first rendering platform and the second rendering platform to produce a single integrated scene. Because the hosting modes may build upon the integrated logical tree, various embodiments may be capable of easily switching among the hosting modes.

### BACKGROUND

Processing devices, such as, for example, personal computers (PCs) provide a number of different ways for building graphical user interfaces (GUIs). Each of the ways for building a GUI includes a model for rendering the GUI and handling layout and input of the GUI. When a GUI was first implemented on a PC, the GUI was generally rendered completely by software using a standard set of application programming interfaces (APIs). Input was handled via messages passed by a system to an application. Eventually, PCs used dedicated hardware to more efficiently render graphics. With dedicated hardware, came new ways to render GUIs to an end user. DirectX® (registered trademark of Microsoft Corporation of Redmond, Wash.) and Windows Presentation Foundation (WPF) are examples of two rendering platforms developed to use dedicated hardware to render graphics. New models for layout and input handling, which use more robust and advanced software architectures, were also developed. Some newer models offered integration options for integrating with earlier technologies. However, not all of the newer models offered integration options.

As a result, a software application developer may choose a single rendering platform from among a number of disparate rendering platforms. For example, many game developers who wish to use the DirectX® rendering platform and the WPF rendering platform to develop a product may resort to using the DirectX® rendering platform and rolling their own version of a control library and input handler to handle items which the application developers otherwise would have preferred to handle via the WPF rendering platform.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a method and a processing device may be provided in which a number of disparate rendering platforms may be integrated to render a single integrated scene. Rendering platforms may include logical trees of controls, which may define relationships among the controls. A logical tree of a first rendering platform may be integrated with a logical tree of a second rendering platform, having controls related to the second rendering platform, to form an integrated logical tree. At least some of the controls of the integrated logical tree may act as placeholders with respect to the second rendering platform. One of a number of different hosting modes may be employed to build upon the integrated logical tree to integrate the first rendering platform and the second rendering platform to produce a single integrated scene.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates a functional block diagram of a processing device, which may be used to implement embodiments consistent with the subject matter of this disclosure.

FIG. 2 illustrates an exemplary integrated hybrid scene, which may be composed in embodiments consistent with the subject matter of this disclosure.

FIG. 3 is a high level flowchart of exemplary processing, which may be performed in embodiments consistent with the subject matter of this disclosure.

FIG. 4 is a flowchart of an exemplary process for performing act 302 of FIG. 3.

FIG. 5 is a flowchart of an exemplary process for creating an integrated scene according to a first hosting mode.

FIG. 6 is a flowchart of an exemplary process for creating an integrated scene according to a second hosting mode.

FIG. 7 is a flowchart of an exemplary process for monitoring events and updating the rendered content in an intermediate format according to the second hosting mode.

FIG. 8 is a flowchart of an exemplary process for creating an integrated scene according to a third hosting mode.

### DETAILED DESCRIPTION

Embodiments are discussed in detail below. While specific implementations are discussed, it is to be understood that this is done for illustration purposes only. A person skilled in the relevant art will recognize that other components and configurations may be used without parting from the spirit and scope of the subject matter of this disclosure.

### Overview

Embodiments consistent with the subject matter of this disclosure may provide a processing device in which a number of disparate rendering platforms may be integrated such that a number of visual components may be rendered into a single integrated scene. Each of the disparate rendering platforms may have different benefits or advantages. For example, DirectX® is a rendering platform which includes a collection of common application programming interfaces (APIs) that provides high performance graphics and sound. WPF is a rendering platform which has various layout algorithms for determining locations and sizes of objects for display in a scene. Other rendering platforms may have other advantages.

Some rendering platforms may not permit a software application developer to use a rendering platform with one or more other rendering platforms. For example, although the WPF rendering platform, itself, may use the DirectX® rendering platform, the WPF rendering platform does not provide the software application developer with direct access to the DirectX® rendering platform.

The WPF rendering platform includes a number of built-in controls including a button, a menu, and a list box. The WPF rendering platform includes a logical tree, which may define relationships among various WPF controls. In some embodiments consistent with the subject matter of this disclosure, the logical tree may be integrated with controls related to another disparate rendering platform such as, for example, DirectX®. Some of the WPF controls may act as placeholders for DirectX® content.

A number of different techniques, called hosting modes, may be used for integrating disparate rendering platforms, such as the WPF rendering platform and the DirectX® rendering platform. The hosting modes may build upon a common integrated logical tree. Because the hosting modes build upon the common integrated logical tree, embodiments consistent with the subject matter of this disclosure may be capable of easily switching among the hosting modes. As a result, a decision regarding which of the hosting modes to use may occur at runtime, may be changed automatically based on processing device attributes or other attributes, or may be manually changed.

### Exemplary Processing Device

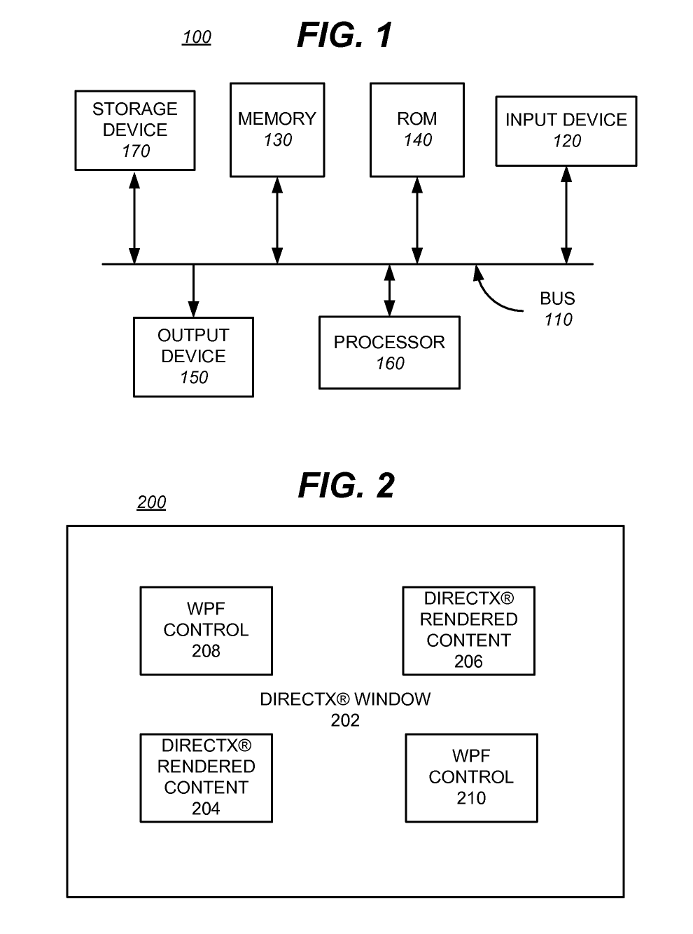

FIG. 1 is a functional block diagram of an exemplary processing device 100, which may be used in embodiments consistent with the subject matter of this disclosure. Processing device 100 may include a bus 110, an input device 120, a memory 130, a read only memory (ROM) 140, an output device 150, a processor 160, and a storage device 170. Bus 110 may permit communication among components of processing device 100.

Processor 160 may include at least one conventional processor or microprocessor that interprets and executes instructions. Processor 160 may further include at least one graphics processor unit (GPU) for graphics processing. Memory 130 may be a random access memory (RAM) or another type of dynamic storage device that stores information and instructions for execution by processor 160. Memory 130 may also store temporary variables or other intermediate information used during execution of instructions by processor 160. ROM 140 may include a conventional ROM device or another type of static storage device that stores static information and instructions for processor 160. Storage device 170 may include a compact disc (CD), digital video disc (DVD), a magnetic medium, or other type of storage device for storing data and/or instructions for processor 160.

Input device 120 may include a keyboard, a joystick, a pointing device or other input device. Output device 150 may include one or more conventional mechanisms that output information, including one or more display screens, or other output devices.

Processing device 100 may perform such functions in response to processor 160 executing sequences of instructions contained in a tangible machine-readable medium, such as, for example, memory 130, ROM 140, storage device 170 or other medium. Such instructions may be read into memory 130 from another machine-readable medium or from a separate device via a communication interface (not shown).

### Logical Integration Layer

A rendering platform such as, for example, WPF, may have a logical tree of controls representing objects. The logical tree may define a relationship among the controls and may include nested controls. In an embodiment including the WPF rendering platform and the DirectX® rendering platform, a first WPF control may be defined as a placeholder, or “empty” control for DirectX® objects and may include information for correct rendering in a DirectX® scene, such as, for example, size and position information, and content to render. The first WPF control may be referred to as DirectXElementControl. A second WPF control may define a placeholder for a clipping region for DirectX® content. The second WPF control may be referred to as DirectXViewControl. A third WPF control may define a singular DirectX® scene. The third WPF controlled may be referred to as DirectXWindowControl. An entire DirectX® scene may fit into one well-defined rectangle on a display screen. In some embodiments, the DirectXWindowControl may create a separate window for the DirectX® scene.

By including, or injecting, appropriate controls in the logical tree, a hybrid scene, such as a scene including WPF and DirectX® components may be composed. Because the WPF rendering platform may automatically position and resize WPF components, injecting the above-mentioned controls into the logical tree may cause the WPF rendering platform to automatically position and resize the injected controls. When the above-mentioned controls are created, the controls may query the WPF rendering platform for details with respect to sizes and positions and may provide the details to the DirectX® rendering platform. The WPF rendering platform may automatically notify the DirectX® rendering platform when locations, or sizes, with respect to the above-mentioned controls, change.

Using the WPF rendering platform for layout purposes may permit various embodiments to utilize the WPF rendering platform event and input scheme. For example, the WPF rendering platform has a rich model for “bubbling” and “tunneling” user input and other events over the logical tree. Bubbling refers to passing information to a parent control within the logical tree and tunneling refers to passing information to a child control within the logical tree. By creating WPF placeholder controls and injecting the WPF placeholder controls into the logical tree, the WPF placeholder controls may be notified of occurrences of events and may react to the events.

FIG. 2 illustrates an exemplary integrated hybrid scene 200, which may be composed in embodiments consistent with the subject matter of this disclosure. Exemplary hybrid scene 200 may include a DirectX® window 202 for a DirectX® scene. The DirectX® scene may include one or more items of DirectX® rendered content 204, 206 and may include one or more WPF controls 208, 210.

### Exemplary Processing

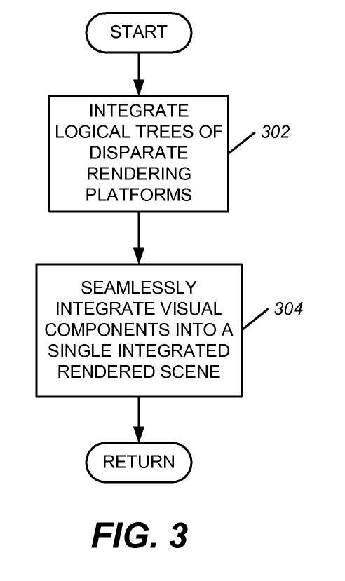

FIG. 3 is a flowchart illustrating exemplary processing, which may be performed in embodiments of processing device 100 consistent with the subject matter of this disclosure. The process may begin with integration of logical trees of disparate rendering platforms to form an integrated logical tree (act 302). The logical trees may include one or more controls of the disparate rendering platforms.

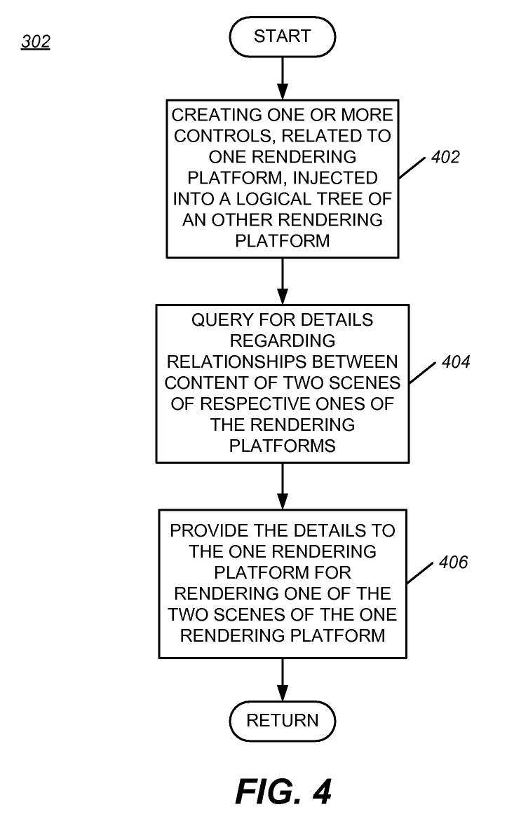

FIG. 4 is a flowchart of an exemplary process for performing act 302 in an embodiment of processing device 100 consistent with the subject matter of this disclosure. The process may begin with creating one or more controls, related to one rendering platform, injected into a logical tree of an other rendering platform (act 402). For example, in some embodiments, as described above with respect to an embodiment that composes a hybrid scene using the WPF rendering platform and the DirectX® rendering platform, one or more WPF controls, acting as placeholders for DirectX® content, may be injected into a WPF logical tree. As discussed above, new WPF controls may be defined, such as, for example, DirectXElementControl, DirectXViewControl, and DirectXWindowControl. DirectXElementControl may serve as a placeholder for DirectX® content. DirectXViewControl may serve as a placeholder for a DirectX® clipping region, in which DirectX® content related to one or more DirectXElementControls may be rendered by the DirectX® rendering platform. DirectXWindowControl may define a window region in which the DirectX® rendering platform may have rights to render content.

Next, the other rendering platform may be queried for details regarding relationships between content of scenes of the two rendering platforms (act 404) Continuing with the example in which the WPF rendering platform and the DirectX® rendering platforms are used to compose a hybrid scene, the WPF rendering platform may automatically position and resize the WPF controls. Having information, with respect to a position and a size of the new WPF controls, as well as a position and a size of the DirectX® scene on a display screen, relationships between the content of the scenes may be determined.

The other rendering platform may then provide the details to the one rendering platform (act 406). Continuing with the above example, the WPF rendering platform may send the information with respect to the position and the size of the new WPF controls and the position and the size of the DirectX® scene to the DirectX® rendering platform for rendering.

Returning to FIG. 3, processing device 100 may seamlessly integrate visual components, corresponding to controls of the integrated logical tree, into a single integrated rendered scene (act 304). The visual components may include buttons, images, and menus, as well as other, or different, visual components. Processing device 100 may integrate visual components using one of several techniques, which may be called hosting modes (to be explained in more detail below).

### Visual Integration Layer

While the logical integration layer may merge logical components, or controls, with respect to scenes rendered by disparate rendering platforms, visual components may not be merged in a same manner. A number of different techniques may be implemented for composing a hybrid scene of the disparate rendering platforms. These techniques may be called hosting modes.

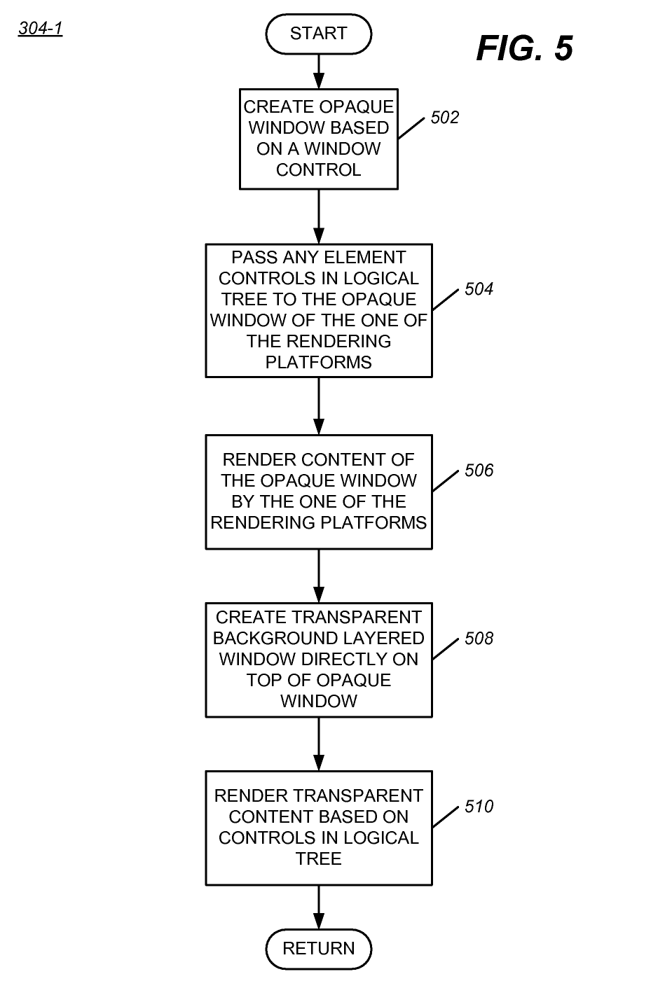

A first hosting mode may be referred to as a layered hosting mode. FIG. 5 is a flowchart illustrating an exemplary process for performing act 304-1, corresponding to act 304 of FIG. 3, according to the layered hosting mode. The process may begin with creating an opaque window based on a window control in a logical tree (act 502). Assuming that a hybrid scene is to be composed using the WPF rendering platform and the DirectX® rendering platform, the opaque window may be created using one of the new controls, discussed above, such as, for example, DirectXWindowControl, to create the opaque window matching a size and a position of the DirectXWindowControl in a WPF logical tree.

Next, any element controls in the logical tree may be passed to the opaque window for rendering at a correct size and position by one of the rendering platforms (act 504). With respect to the above example, DirectXElementControls in the WPF logical tree may be passed to a DirectX® window.

Processing device 100 may then render content of the opaque window by the one of the rendering platforms (act 506). Continuing with the above example, the DirectX® rendering platform may render a DirectX® window including content corresponding to the DirectXElementControls in the WPF logical tree.

Processing device 100 may then create a transparent background layered window sitting directly on top of the opaque window (act 508). An other of the rendering platforms (for example, the WPF rendering platform) may render a visual representation of the integrated logical tree (act 510). For example, WPF controls may be presented on top of the DirectX® window. Because the DirectXElementControl may be a placeholder and thus, empty, the DirectXElementControl may be rendered as transparent by the WPF rendering platform, allowing the DirectX® window to be seen through the transparent background layered window. As a result, two disparate rendering platforms may be used to compose a single unified scene.

A second hosting mode may be referred to as a RenderToBitmap hosting mode. The RenderToBitmap hosting mode may be used to compose the single unified scene by using an intermediate format. For example, with respect to the DirectX® rendering platform and the WPF rendering platform, although the DirectX® rendering platform may not render WPF controls, the DirectX® rendering platform may render bitmap images. Further, the WPF rendering platform may render a control, or a logical tree of controls to bitmap images. In the RenderToBitmap hosting mode, a control such as, for example, the DirectXWindowControl, may cause a logical tree to be walked, such as the integrated logical tree, looking for WPF controls, which may be flagged for rendering in a DirectX® scene. For each of the WPF controls found, the found WPF controls may be rendered by the WPF rendering platform into a bitmap form. The WPF rendering platform may determine a size and location corresponding to the WPF controls in the logical tree and may pass the rendered bitmap form and information with respect to the size and the location to the DirectX® rendering platform.

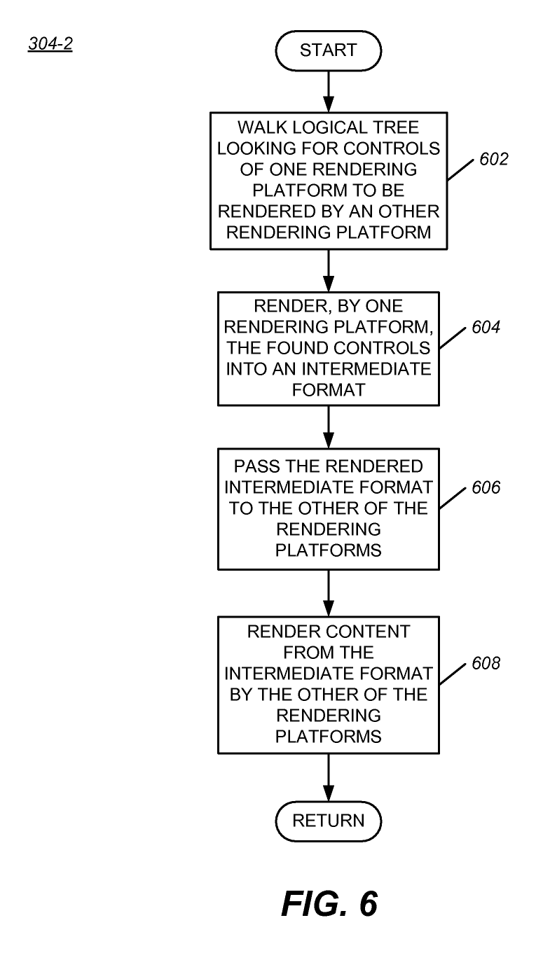

FIG. 6 is a flowchart illustrating an exemplary process for performing act 304-2, corresponding to act 304 of FIG. 3, with respect to the second hosting mode. The process may begin with walking an integrated logical tree looking for controls of one rendering platform to be rendered to an other rendering platform (act 602). For example, the WPF logical tree may be walked to look for WPF controls to be rendered to the DirectX® rendering platform. The found controls may be rendered by the one rendering platform to an intermediate format, such as, for example, a bitmap format (act 604). The rendered intermediate format may be passed to the other rendering platform, such as, for example, the DirectX® rendering platform. Content in the intermediate format may then be rendered by the other rendering platform (act 608).

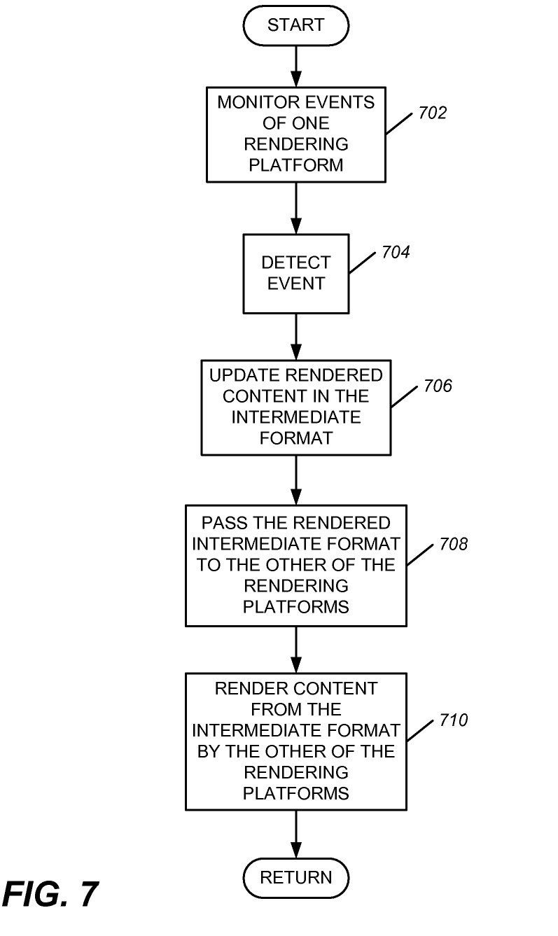

In all of the hosting modes, events may be monitored for logical changes, including indications of changes in size or position, such that the changed size or position may be communicated to a secondary rendering platform. In an embodiment in which hybrid scenes may be composed using the DirectX® rendering platform and the WPF rendering platform, a window control, such as, for example, the DirectXWindowControl, may monitor events for visual changes from the WPF rendering platform. When such an event is detected, the WPF rendering platform may render an updated bitmap for the DirectX® rendering platform. FIG. 7 is a flowchart illustrating an exemplary process for monitoring and updating a bitmap in this embodiment.

The process may begin with a window control causing events from one rendering platform, such as, for example, the WPF rendering platform, to be monitored for events with respect to visual changes (act 702). Next, an event may be detected as a result of monitoring (act 704). The one rendering platform, for example, the WPF rendering platform, may update rendered content in an intermediate format by, for example, rendering an updated bitmap (acts 706). The one rendering platform may pass the intermediate format to an other rendering platform, such as, for example, the DirectX® rendering platform (act 708). The other rendering platform may then render content from the intermediate format (act 710).

When using the RenderToBitmap hosting mode with the WPF rendering platform and the DirectX® rendering platform, as discussed above, a window of the WPF rendering platform may not be a topmost window. Therefore, the WPF rendering platform may not be in a position to handle user input. Instead, the user input may be received by a window of the DirectX® rendering platform. In some embodiments, a handler may be placed in the window of the DirectX® rendering platform to catch the user input and pass it to the underlying window of the WPF rendering platform. In an alternate embodiment, instead of using the above-mentioned handler, support may be provided for disabling input for the topmost window. Thus, the window of the WPF rendering platform may receive the user input as if the window of the WPF rendering platform is the topmost window. As a result, applications built using this hosting mode may use a native WPF event scheme.

A third hosting mode may be referred to as a DirectXAsVideo hosting mode. This hosting mode is similar to the RenderToBitmap hosting mode. As mentioned above, the RenderToBitmap hosting mode may render WPF content to an intermediate format, such as, for example, a bitmap format, for use by the DirectX® rendering platform. The DirectXAsVideo hosting mode may render DirectX® content to an intermediate format, such as, for example, video, which the WPF rendering platform may understand.

In various embodiments, a “video provider” for video input may be created for the WPF rendering platform. As the WPF rendering platform requests successive frames from the video provider, the WPF rendering platform may read a current state of a DirectX® scene. A native layering functionality of the WPF rendering platform may place video behind other WPF controls, resulting in a visual very similar to a visual produced using the layered hosting mode. However, in the DirectXAsVideo hosting mode, layering is performed by the WPF rendering platform in a single window.

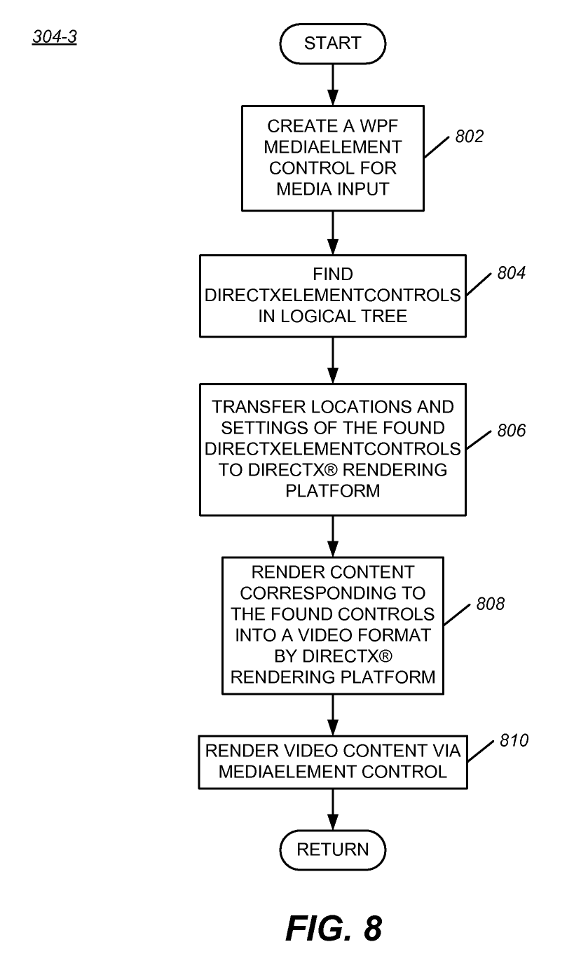

FIG. 8 is a flowchart illustrating exemplary processing in an embodiment which uses the DirectXAsVideo hosting mode to compose a scene using the WPF rendering platform and the DirectX® rendering platform. First, the process may begin with creation of a WPF MediaElement control for media input (act 802). The WPF MediaElement may be wired to an off-screen DirectX® scene. Appropriate DirectXElementControls in the integrated logical tree may be found (act 804) and locations and settings of the DirectXElementControls may be transferred to the DirectX® rendering platform for rendering an item at a correct size and location (act 806). Content corresponding to the found DirectXElementControls may then be rendered into an intermediate format, such as, for example, video (act 808). Content may then be rendered from the intermediate format. This may be performed by the WPF rendering platform receiving the video input and rendering the contents from the video input via the MediaElement control (act 810).

### Host Switching

In various embodiments, each of the above-mentioned hosting modes may be based on a same set of core controls, such as , for example, WPF controls. As a result, switching from one of the hosting modes to another of the hosting modes may be performed with little or no effort. For example, a decision regarding which of the hosting modes to use may occur as late as runtime, and may be changed automatically based on a number of factors, such as, for example, machine or scenario attributes, or may be changed manually.

### Miscellaneous

Although the above examples describe embodiments in which the DirectX® rendering platform and the WPF rendering platform may produce an integrated hybrid scene, embodiments consistent with the subject matter of this disclosure are not limited to embodiments using only the DirectX® rendering platform and the WPF rendering platform. For example, in other embodiments consistent with the subject matter of this disclosure other disparate rendering platforms may be used together to produce a hybrid scene, or other combinations of rendering platforms, which may or may not include either the DirectX® rendering platform or the WPF rendering platform, may be used together to produce a hybrid scene.

### Conclusion

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents define the invention, rather than any specific examples given.

We claim as our invention:

1. A machine-implemented method for integrating disparate rendering platforms on a processing device, the machine-implemented method comprising:
integrating a plurality of logical trees of the disparate rendering platforms such that a layout and an input of the disparate rendering platforms are handled uniformly; and
seamlessly integrating, based on the integrated plurality of logical trees, a plurality of visual components of the disparate rendering platforms into a single integrated rendered scene.

2. The machine-implemented method of claim 1, wherein the integrating of a plurality of logical trees of the disparate rendering platforms further comprises:
creating at least one control, related to a first one of the disparate rendering platforms;
injecting the at least one control into a logical tree of a second one of the disparate rendering platforms;
querying the second one of the disparate rendering platforms, by the at least one control, for details regarding relationships between content in a first scene of the second one of the disparate rendering platforms and content in a second scene of the first one of the rendering platforms;
providing the details to the first one of the disparate rendering platforms for rendering of the second scene.

3. The machine-implemented method of claim 1, wherein the seamlessly integrating, based on the integrated plurality of logical trees, of a plurality of visual components of the disparate rendering platforms into a single integrated rendered scene further comprises:
creating an opaque window with respect to a first one of the disparate rendering platforms based on a window control of the at least one control,
creating a transparent background layered window, with respect to a second one of the disparate rendering platforms, the transparent background layered window being located directly on top of the opaque window, and
rendering content of the opaque window by the first one of the disparate rendering platforms according to one or more controls of the at least one control.

4. The machine-implemented method of claim 1, wherein the seamlessly integrating, based on the integrated plurality of logical trees, of a plurality of visual components of the disparate rendering platforms into a single integrated rendered scene further comprises:
creating an opaque window with respect to a first one of the disparate rendering platforms based on a window control of the at least one control,
creating a transparent background layered window, with respect to a second one of the disparate rendering platforms, the transparent background layered window being located directly on top of the opaque window,
rendering content of the opaque window by the first one of the disparate rendering platforms according to one or more controls of the at least one control, and
rendering, as transparent, one or more of the at least one control by the second one of the disparate rendering platforms.

5. The machine-implemented method of claim 1, wherein the seamlessly integrating, based on the integrated plurality of logical trees, of a plurality of visual components of the disparate rendering platforms into a single integrated rendered scene further comprises:
rendering at least one control, of the integrated plurality of logical trees, by a second one of the disparate rendering platforms to produce a rendered output in an intermediate format;
passing the rendered output in the intermediate format to a first one of the disparate rendering platforms; and
rendering, by the first one of the disparate rendering platforms, a scene based on the rendered output in the intermediate format.

6. The machine-implemented method of claim 1, wherein the seamlessly integrating, based on the integrated plurality of logical trees, of a plurality of visual components of the disparate rendering platforms into a single integrated rendered scene further comprises:
rendering at least one control, of the integrated plurality of logical trees, by a second one of the disparate rendering platforms to produce a rendered output in a bitmap format,
passing the rendered output in the bitmap format to a first one of the disparate rendering platforms, and
rendering, by the first one of the disparate rendering platforms, a scene based on the rendered output in the bitmap format; and
the machine-implemented method further comprises:
receiving user input via a window of the first one of the disparate rendering platforms;
passing the user input to an underlying window of the second one of the disparate rendering platforms; and
detecting an event from the second one of the disparate rendering platforms, and updating the rendered output in the bitmap format upon detecting the event.

7. The machine-implemented method of claim 1, wherein the seamlessly integrating, based on the integrated plurality of logical trees, of a plurality of visual components of the disparate rendering platforms into a single integrated rendered scene further comprises:
rendering at least one control, of the integrated plurality of logical trees, by a first one of the disparate rendering platforms to produce a rendered video output, and
rendering, by a second one of the disparate rendering platforms in a single window, a scene based on the rendered video output.

8. A processing device comprising:
at least one processor; and
a memory connected to the at least one processor, the memory including:
instructions for integrating a plurality of logical trees of disparate rendering platforms such that a layout and an input of the disparate rendering platforms are handled uniformly, and
instructions for seamlessly integrating, based on the integrated plurality of logical trees, a plurality of visual components of the disparate rendering platforms into a single integrated rendered scene using one of a plurality of hosting modes.

9. The processing device of claim 8, wherein the memory further comprises:
instructions for switching from one of the plurality of hosting modes to another of the plurality of hosting modes.

10. The processing device of claim 8, wherein the memory further comprises:
instructions for switching from one of the plurality of hosting modes to another of the plurality of hosting modes at runtime.

11. The processing device of claim 8, wherein the disparate rendering platforms comprise Windows Presentation Foundation and DirectX.

12. The processing device of claim 8, wherein the memory further comprises:
instructions for injecting a control for content from a first one of the plurality of rendering platforms into the integrated plurality of logical trees, the control being a placeholder with respect to a second one of the plurality of disparate rendering platforms.

13. The processing device of claim 8, wherein the instructions for seamlessly integrating, based on the integrated plurality of logical trees, a plurality of visual components of the disparate rendering platforms into a single integrated rendered scene using one of a plurality of hosting modes further comprise:
instructions for creating an opaque window with respect to a first one of the disparate rendering platforms,
instructions for creating a transparent background layered window, with respect to the second one of the disparate rendering platforms, the transparent background layered window being located directly on top of the opaque window, and
rendering content of the opaque window by the first one of the disparate rendering platforms.

14. The processing device of claim 8, wherein the instructions for seamlessly integrating, based on the integrated plurality of logical trees, a plurality of visual components of the disparate rendering platforms into a single integrated rendered scene using one of a plurality of hosting modes further comprise:
rendering at least one control, of the integrated plurality of logical trees, by a first one of the disparate rendering platforms to produce a rendered output in an intermediate format;
inputting, by a second one of the disparate rendering platforms, the rendered output in the intermediate format; and
rendering, by the second one of the disparate rendering platforms, a scene based on the rendered output in the intermediate format.

15. A tangible machine-readable medium having instructions recorded thereon for at least one processor of a processing device, the instructions comprising:
instructions for integrating a plurality of logical trees of disparate rendering platforms such that a layout and an input of the disparate rendering platforms are handled uniformly, the integrating further comprising injecting at least one control, related to a first one of the rendering platforms, into a logical tree of a second one of the plurality of rendering platforms, one of the at least one control being a placeholder, with respect to the second one of the plurality of rendering platforms, for an element of a scene of the first one of the rendering platforms; and
instructions for seamlessly integrating, based on the integrated plurality of logical trees, a plurality of visual components of the disparate rendering platforms into a single integrated rendered scene using one of a plurality of hosting modes.

16. The tangible machine-readable medium of claim 15, wherein the instructions further comprise:
instructions for rendering a control, of the integrated plurality of logical trees, by one of the disparate rendering platforms to produce a rendered output in an intermediate format,
instructions for inputting, by an other one of the disparate rendering platforms, the rendered output in the intermediate format,
instructions for rendering, by the one of the disparate rendering platforms, a scene based on the rendered output in the intermediate format, and
instructions for monitoring events of the other one of the disparate rendering platforms and for updating the rendered output in the intermediate format.

17. The tangible machine-readable medium of claim 15, wherein the instructions further comprise:
instructions for automatically switching to a different one of the plurality of host modes to seamlessly integrate the plurality of visual components of the disparate rendering platforms into the single integrated rendered scene.

18. The tangible machine-readable medium of claim 15, wherein the instructions for seamlessly integrating, based on the integrated plurality of logical trees, a plurality of visual components of the disparate rendering platforms into a single integrated rendered scene using one of a plurality of hosting modes further comprise:
instructions for creating an opaque window with respect to a first one of the disparate rendering platforms,
instructions for creating a transparent background layered window, with respect to the second one of the disparate rendering platforms, the transparent background layered window being located directly on top of the opaque window and being created as a result of the one of the at least one control being the placeholder, and
instructions for rendering content of the opaque window by the first one of the disparate rendering platforms.

19. The tangible machine-readable medium of claim 15, wherein the at least one control comprises:
a first control as a placeholder, with respect to the second one of the plurality of disparate rendering platforms, and including details with respect to being correctly rendered in a scene of the first one of the disparate rendering platforms,
a second control to define a clipping region, with respect to content of the first of the plurality of disparate rendering platforms, the second control acting as a placeholder, with respect to the second one of the disparate rendering platforms, for the clipping region of the content of the first of the plurality of disparate rendering platforms, and
a third control, with respect to the second one of the plurality of disparate rendering platforms, to define a scene of the first one of the plurality of disparate rendering platforms.

20. The tangible machine-readable medium of claim 15, wherein the instructions further comprise:
instructions for rendering a control, of the integrated plurality of logical trees, by one of the disparate rendering platforms to produce a rendered output in an intermediate format,
instructions for inputting, by an other one of the disparate rendering platforms, the rendered output in the intermediate format,
instructions for rendering, by the one of the disparate rendering platforms, a scene based on the rendered output in the intermediate format, and
instructions for monitoring events of the other one of the disparate rendering platforms and for updating the rendered output in the intermediate format, wherein:
the intermediate format includes a format selected from a plurality of formats including a bitmap format and a video format.
